(19) United States
(12) Patent Application Publication
(10) Pub. No.: US 2014/0122991 A1
(43) Pub. Date: May 1, 2014

(54) FAST ANNOTATION OF ELECTRONIC CONTENT AND MAPPING OF SAME

(71) Applicant: IMC TECHNOLOGIES SA, (US)

(72) Inventor: EVANGELOS ACHILLOPOULOS, CHALANDRI (GR)

(73) Assignee: IMC TECHNOLOGIES SA, Chalandri (GR)

(21) Appl. No.: 13/850,293

(22) Filed: Mar. 25, 2013

Related U.S. Application Data
(60) Provisional application No. 61/615,336, filed on Mar. 25, 2012.

(51) Int. Cl. G06F 17/24

(52) U.S. Cl. CPC G06F 17/241
USPC 715/230

(57) ABSTRACT

The present disclosure is directed to improved techniques to allow users with simple actions to perform a set of interactions at once in order to express a quantitative rating (positive or negative), tag an expression from a pre-defined set of expressions and at same time capture a selected range of text or image portion to be possibly quoted or highlighted in a comment. This information is then employed to generate a graphical user interface including a multi-dimensional map to represent the attribute information, and the electronic content, where the multi-dimensional map comprises at least color, size and direction characteristics.

### RELATED APPLICATIONS

This application claims the benefit of U.S. Provisional Applications No. 61/615,336 filed on Mar. 25, 2012, and No. 61/645,781 filed on May 11, 2012, commonly owned and assigned to the same assignee hereof.

### BACKGROUND

1. Field

The present disclosure is directed to techniques for reviewing, assessing and commenting on-line and other electronic content including text and images to generate attribute information; as well as improved techniques for processing and uniquely displaying attribute information.

2. Background

With the explosion of internet content, there is an increasing demand for intelligent analysis and dissemination of the vast amount of available text in blogs, news feeds, public consultations, images and such. It is becoming common for text and image content to include comments from readers expressing their opinion. This opinion could be negative or positive, it could be an argument in favor or against, but in all instances, it is a form of general interacting with other readers and/or authors and/or content owners.

Currently available commenting systems allow simple text entry, likes and/or dislikes, and star ratings. Some systems allow quoting another commenter comments as a whole and manually editing it, allowing the commenter to focus his comment on the exact sentence he or she wants to address an opinion.

Conventional techniques utilize simple rating schemes employing for example stars to indicate likes and/or dislikes, and other similar annotation systems, all of which serve as a primitive level of crowd sourced human assistance to semantic analysis engines.

The level of sophistication and the amount of user contribution is directly connected to the user friendliness of the input process and the depth of expressiveness it can provide. There is a direct correlation between the degree of complication of the inputting process (i.e., the more clicks, selections and typing involved) and the level of user participation.

An exemplary system for administering commenting between web-based browser user interfaces between client devices and remote servers is well known, as shown and described in U.S. Pat. No. 8,291,014, incorporated herein by reference.

With conventional techniques, semantic analysis of text becomes more difficult when unstructured commenting is provided. There is a need therefore for improved techniques of providing commenting to text and images that is user friendly, easy to assess, and relatively easy for semantic analysis to be performed on such commenting in a fully automated manner.

### SUMMARY

The present disclosure is directed to improved techniques to allow users with simple actions to perform a set of interactions at once in order to express a quantitative rating (positive or negative), tag an expression from a pre-defined set of expressions (opinion, mood, agreement) and at same time capture a selected range of text or image portion to be possibly quoted or highlighted in a comment. The proposed solution provides a more user friendly annotation scheme with a minimum of initial repetitions.

The proposed annotation tool is easy to learn, provides more extensive user interaction and expressiveness, resulting in higher user participation, and at same time provides a more sophisticated interface for a semantic content analysis engine.

In accordance with an exemplary embodiment, the proposed methodology involves providing an interface to allow a user to select content in an electronic document to be commented on. The user selected content is identified and an interface provided to allow a user to identify attribute information of the selected content. The received attribute information, together with the selected content and any received comments for that selected content are stored in a manner to allow useful processing by a semantic content analysis engine.

In accordance with a further exemplary embodiment, captured notations, and specifically attribute information, comprised of ratings and/or expressions, are multi-dimensionally mapped in a manner that results in very fast, user-friendly interpretation of presented material to viewers. The multi-dimensional map comprises at least color, size and direction characteristics.

In one scenario, selection of attribute information is facilitated by drop down menus that are generated on or near a selected passage (electronic content) to be notated. Intuitive mouse actions provide activate, select, deselect, delete and/or rotate functionality and control. In an alternate scenario, speech processing and/or biometric type selection is provided.

In yet a further scenario, attribute selection functionality is triggered by intuitive gestures. In one implementation, a gesturing approach involves using two fingers, or a thumb and a finger, to perform a multitude of functions. Gesturing is a more suitable notation methodology for smaller portable devices, such as smart phones and similar touch screen enabled tablet devices, where there is no mouse. In one implementation, gesturing is achieved by a user's thumb, in the hand holding the device, tapping “on or near” a corner of a screen real estate, while an index finger in the opposite hand scrolls, selects, deselects. Other gesturing methods, including a combination of any of the above described techniques, are also contemplated.

In a further scenario, in addition to selection of attribute information there is provided the ability to not only identify a passage to be annotated, but also to “pull” the passage as a quote into a comment field section.

In a further scenario, the quote, once selected may be set off as a link and shared by way of email, uploaded to a social network site for others to comment. Once link shared, the link remains dynamically linked back to the authoring page, and any attribute information generated by one or more users at the receiving end (e.g., on FACEBOOK or TWITTER) are processed and mapped in the same way as if the attribute information were made on the author's site.

In one implementation, a remote server automatically activates an appropriate software module to enable the annotation tool. The software module is activated in response to the same server or a related server receiving a request from a client device to make an electronic document available to it.

In another scenario, the software module is local to the client device and activated by a browser downloading a web page, email, electronic document, a received quote from another client, or automatically when logging in to a particular site, or social network community, such as FACEBOOK or TWITTER.

In yet a further scenario, the electronic document is a non-web page document with the annotation tool being provided as add-on tool, e.g., (i) to a word processing program, such as WORD; or (ii) to an image creation too, such as VISIO. When the non-web page document is distributed or otherwise shared among a large community of members, the annotation tool is either active on the background when the document is launched by the relevant executable program, or otherwise launched by the client device of the individual member when opening the non-web page document.

In yet a further implementation, the mapping of attribute information results in being able to identify a range of different user participation activity—as evidenced by the number of user selections to generate attribute information—about a particular passage or sets of passages. An area of high interest and activity provides a variety of targeted advertising, and opens the door for a variety of monetization schemes. In one monetization strategy, the owner of the site may vary the price it charges for advertising based on the level of visitor interest, as determined by dynamically provided and mapped attribute information, about a particular topic.

In another monetization strategy, the advertiser is a dynamically generated advertisement served up by an ad server with which the site is registered, such as Google Adsense, Google Adwords, affiliate managers such as Amazon, Linkshare, and like ad serving platforms.

In one implementation, the ad serving platform scans the page to analyze the mapped attribute information. Image recognition is employed to identify—based on interpretation of graphical contents—the areas of highest activity, and thus most valuable from ad placement perspective. Premium ads are served at areas of high activity. Advertisers may charge different prices for targeted advertising to the same or different customers based on activity level of attribution information about a given page,

When the affiliate ad is an embedded word type ad generated by hovering over a certain keyword or keywords (for example “SAMSUNG GALAXY”), or an image of a device associated with these same words, then the value to acquire such words or images, is set at a premium when they appear in high activity areas.

Passages in high activity areas—in terms of attribution information mapping—are also more likely to be quoted in relevant commenting fields or exported to other members and/or community network sites. When this occurs, embedded ads are circulated beyond the original site, creating an opportunity for exposure to a wider audience.

In an alternate monetization approach, an ad manipulation tool is provided which changes embedded ads associated with quotes that are reproduced in comment fields, and/or exported. The changes may involve (i) simply changing the tracking id in the ad to the notator-associated tracking id for that same merchant or advertiser, or, alternatively, (ii) completely replacing the ad with a different ad from a different merchant or advertiser with whom the notator is affiliated.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a high level architecture diagram of an exemplary environment in which systems and methods described herein may be implemented;

FIG. 2 is a diagram of exemplary components of a client or a server of FIG. 1.

FIG. 3 is a diagram of functional components of a server of FIG. 1.

FIGS. 4-15 are screen shots for graphically communicating attribute information selections associated with content on electronic pages in accordance with various associated exemplary embodiments.

FIG. 16 is a high level flowchart in accordance with an exemplary embodiment.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

A number of exemplary embodiments will now be described.

In all, the present disclosure describes improved techniques to allow users with simple mouse actions to perform a set of interactions at once in order to express a quantitative rating (positive or negative, like or dislike, agree or disagree; or a range thereof such as a number from 1-10, where for example a “1” is I agree entirely and a “10” I disagree entirely, while a “5” is I neither entirely agree or disagree). In addition to quantitative ratings, a user may using same simple mouse actions also hover and select over a choice of appearing options that allow the user to assign an “expression tag” from a pre-defined set of expression attributes presented to the user, such as whether the section of interest selected by the user is going to be, for example, an opinion, mood, or agreement attribute. Furthermore, at same time, the section of interest, may be captured, and the text or image associated therewith, may be automatically copied into a comment section, or caused to act as a link The link may be shared by, for example, including the link in an email (either manually or automatically generated), by posting the link on a website (e.g., Twitter, Facebook, etc.), by posting the link in a Blog (e.g., Blogger, etc.), or by sending the link via an Instant Message (IM). The link may also be available in a “profile” associated with the user. The “profile” may include information about the user that other users may access. The link may also be shared via any other equivalent mechanism.

The acts of “rating”, assigning an expression attribute, and selecting a passage as a quote to be used or shared, shall collectively hereinafter be referred to as “attribute information.”

The disclosed techniques aim to provide a more user friendly notation scheme with a minimum of initial repetitions to visually represent attribute information from many annotators simultaneously. The proposed notation is easy to learn, provides extensive user interaction and expressiveness, resulting in higher user participation, and at same time provides a more sophisticated interface for semantic content analysis engines.

The proposed methodology involves providing an intelligent interface to allow a visitor to a site (user) to fast notate passages of interest. In one regard, the notation scheme that is proposed is akin to a digital highlighter system of notation, very similar to what many students use in notebooks: where one color may be used to reflect to the student to come back and reread a section, or to notate (using a different color) that the student does not agree with author, or through the use of a large number of differently colored highlighters, create impressions and associations for the student, that make it is easy for the student (and for that matter anyone else familiar with meaning of color scheme) to go back and extract from text the most relevant sections or passages to revisit and in what order of priority given time constraints, future interest, general importance, or similar considerations.

While there is generally wide overlap as to some sections, in that many would agree that the conclusion of long thesis is important, there are many other sections, where most people would each come up with quite different levels of annotation. If many people were to share a book, the process of highlighting using colored highlighters is no longer efficient or practical.

However, sharing is exactly what digital electronic content is all about. It is highly desirable for people to be able to share their annotations online. Unfortunately, traditional highlighting, while available, does not quite address the problem of one reading a passage that someone else published on the web, and wanting to express an opinion, like or dislike about the passage for example, with the intent of soliciting third party feedback. And it certainly does not address the need to be able to do this for many, many passages, some of them in the same sentence or paragraph, and to do so using a tool that is very user friendly.

While commenting tools are known, they do not do a good job of graphically communicating what heretofore is described as “attribute information.”

At the end of the day, however, what is needed is a user-friendly way to compile all this information from all the potential pool of annotators, but at the same time, do it in a way, that is at the same time easy for the annotator to select from a variety appropriate attribute information options.

The user selected content is identified and an interface provided to allow a user to identify attribute information of the selected content. The received attribute information, together with the selected content and any received comments for that selected content are stored in a manner to allow useful processing by a semantic content analysis engine.

The proposed computer user interface may be driven with mouse clicks or the equivalent actions (gestures), such as fingers pressed on a multi touch capable screen, or via an intelligent set of pre-defined voice commands.

A “comment”, as used herein, may include text, audio data, video data, and/or image data that provide an opinion of, or otherwise remarks upon, the electronically-presented contents (“electronic content”) of a document or a portion of a document. “Rating” of a passage in a document, is the act of assigning an expression attribute to that passage, independent of whether that passage will be commented on separately.

The most typical type of comment is a statement the sole purpose of which is to express an opinion/remark on something presented by one's browser while viewing a page associated with a specific URL.

A “document,” as the term is used herein, is to be broadly interpreted to include any machine-readable and machine-storable work product. A document may include, for example, an e-mail, a web site, a file, a combination of files, one or more files with embedded links to other files, a news group posting, a news article, a blog, a business listing, an electronic version of printed text, a web advertisement, etc.

In the context of the Internet, a common document is a web page. Documents often include textual information and may include embedded information (such as meta information, images, hyperlinks, etc.) and/or embedded instructions (such as Javascript, etc.). A “link,” as the term is used herein, is to be broadly interpreted to include any reference to/from a document from/to another document or another part of the same document.

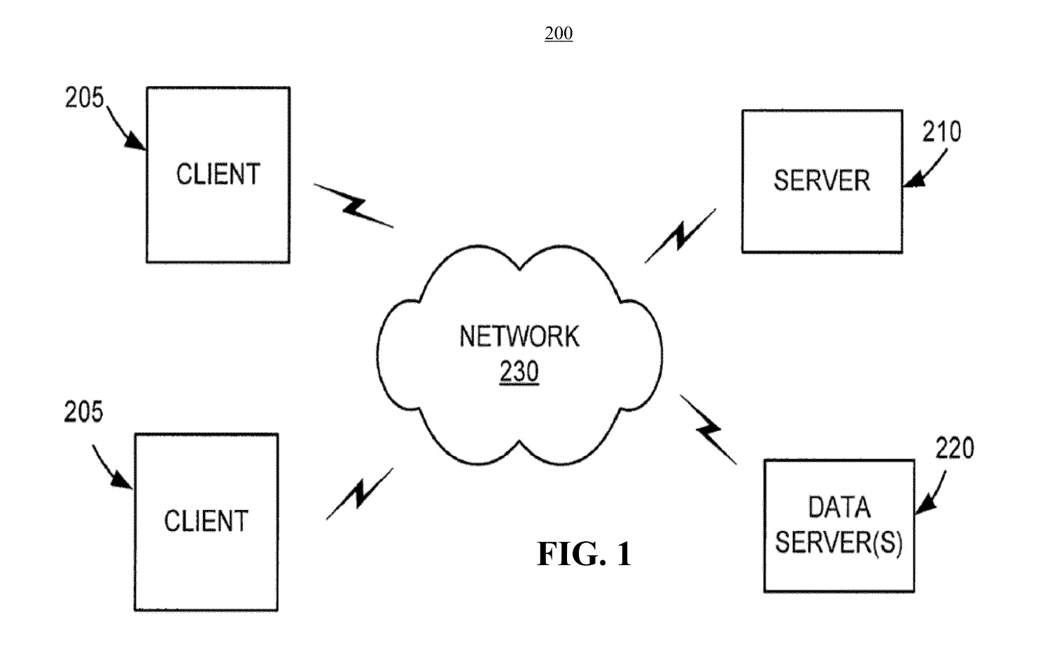

FIG. 1 is a high level architecture diagram of an exemplary environment in which systems and methods described herein may be implemented.

Environment 200 may include multiple clients 205 connected to multiple servers 210 and 220 via a network 230. Two clients 205 and two servers (e.g., server 210 and data server(s) 220) have been illustrated as connected to network 230 for simplicity. In practice, there may be more or fewer clients and servers. Also, in some instances, a client may perform a function of a server and a server may perform a function of a client.

Clients 205 may include client entities. An entity may be defined as a device, such as a personal computer, a wireless telephone, a personal digital assistant (PDA), a lap top, or another type of computation or communication device, a thread or process running on one of these devices, and/or an object executed by one of these devices. In one implementation, a client 205 may include a user interface (e.g., a browser application) that permits documents to be searched and/or accessed. Client 205 may also include software, such as a plug-in, an applet, a dynamic link library (DLL), or another executable object or process, that may operate in conjunction with (or be integrated into) the user interface to allow, through simple mouse actions, or tactile gestures on a touch screen, or by mere voice commands, to obtain and display expression attributes, ratings, and make selection of passages. Client 205 may obtain the software from search server 210 or from a third party, such as a third party server, disk, tape, network, CD-ROM, etc. Alternatively, the software may be pre-installed on client 205.

In one implementation, as described herein, the browser may provide an advanced notation scheme. The advanced notation may permit a user to select among various predefined attributes (and even create comments) regarding a passage in a document, permit the user to view and gain a general impression of the passages that are of most interest or highest relevance, based on mapped visual representations of the attribute information made by all.

Data server(s) 220 may store or maintain documents that may be browsed by clients 205, or may be crawled by server 210. Such documents may include data related to published news stories, products, images, user groups, geographic areas, or any other type of data. For example, data server(s) 220 may store or maintain news stories from any type of news source, such as, for example, CNN, Yahoo, AOL, or Financial Times.

As another example, data server(s) 220 may store or maintain data related to specific products, such as product data provided by one or more product manufacturers. As yet another example, data server(s) 220 may store or maintain data related to other types of documents, such as pages of web sites (e.g., web content).

In yet another example, data server(s) 220 may store or maintain static and/or dynamically served advertisements. In one scenario, client 205 may also include further software, such as a plug-in, an applet, a dynamic link library (DLL), or another executable object or process, that may operate in conjunction with (or be integrated into) the user interface to obtain and display advertisements. Google Adsense, Adwords, affiliate network manager and the like are examples of software that may be used to serve advertisements. Semantic analysis engines, which employ keyword or keyword associations, may also be employed to maximize monetization of a web page or like electronic content page or document.

While servers 210 and 220 are shown as separate entities, it may be possible for one or more of servers 210-220 to perform one or more functions of another one or more of servers 210-220. For example, it may be possible that two or more of servers 210-220 are implemented as a single server. It may also be possible for a single one of servers 210-220 to be implemented as two or more separate (and possibly distributed) devices.

Network 230 may include any type of network, such as a local area network (LAN), a wide area network (WAN), a telephone network (e.g., the Public Switched Telephone Network (PSTN) or a cellular network), an intranet, the Internet, or a combination of networks. Clients 205 and servers 210-220 may connect to network 230 via wired and/or wireless connections.

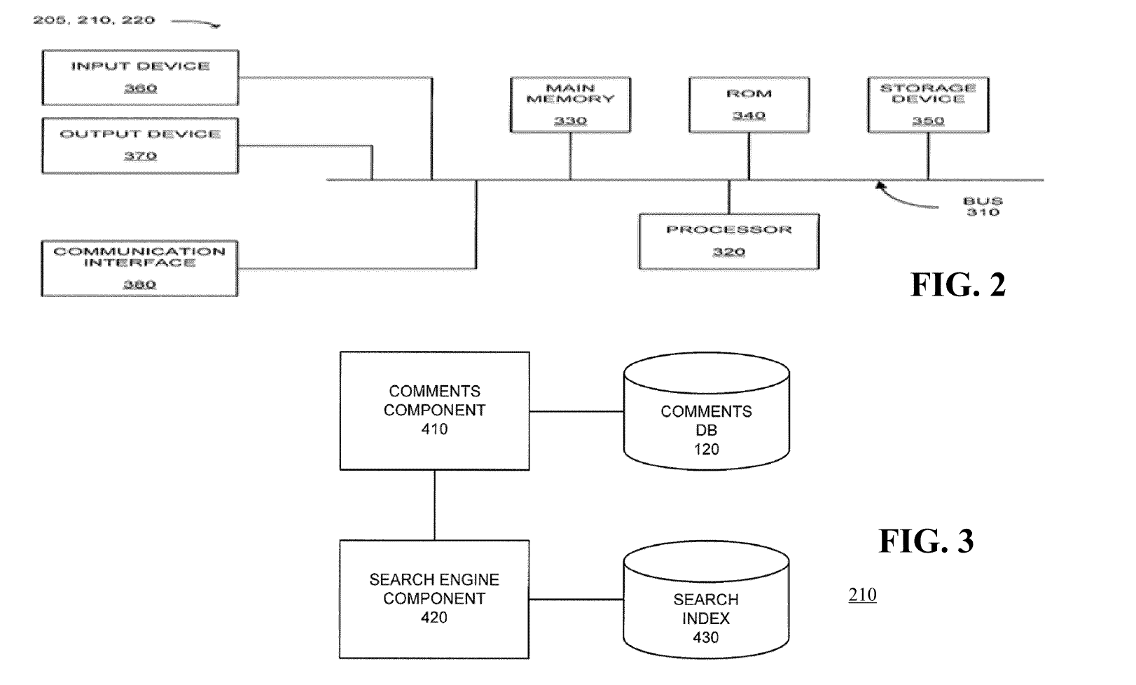

FIG. 2 is a diagram of exemplary components of a client or server entity (hereinafter called “client/server entity”), which may correspond to one or more of clients 205 and/or servers 210-220. As shown in FIG. 3, the client/server entity may include a bus 310, a processor 320, a main memory 330, a read only memory (ROM) 340, a storage device 350, an input device 360, an output device 370, and a communication interface 380. In another implementation, client/server entity may include additional, fewer, different, or differently arranged components than are illustrated in FIG. 2.

Bus 310 may include a path that permits communication among the components of the client/server entity. Processor 320 may include a processor, a microprocessor, or processing logic (e.g., an application specific integrated circuit (ASIC) or a field programmable gate array (FPGA)) that may interpret and execute instructions. Main memory 330 may include a random access memory (RAM) or another type of dynamic storage device that may store information and instructions for execution by processor 320. ROM 340 may include a ROM device or another type of static storage device that may store static information and instructions for use by processor 320. Storage device 350 may include a magnetic and/or optical recording medium and its corresponding drive, or a removable form of memory, such as a flash memory.

Input device 360 may include a mechanism that permits an operator to input information to the client/server entity, such as a keyboard, a mouse, a button, a pen, a touch screen, voice recognition and/or biometric mechanisms, etc. Output device 370 may include a mechanism that outputs information to the operator, including a display, a light emitting diode (LED), a speaker, etc. Communication interface 380 may include any transceiver-like mechanism that enables the client/server entity to communicate with other devices and/or systems. For example, communication interface 380 may include mechanisms for communicating with another device or system via a network, such as network 230.

As will be described in detail below, the client/server entity may perform certain operations relating to the generation and presentation of comments. The client/server entity may perform these operations in response to processor 320 executing software instructions contained in a computer-readable medium, such as memory 330. A computer-readable medium may be defined as a logical or physical memory device. A logical memory device may include a space within a single physical memory device or spread across multiple physical memory devices.

The software instructions may be read into memory 330 from another computer-readable medium, such as storage device 350, or from another device via communication interface 380. The software instructions contained in memory 330 may cause processor 320 to perform processes that will be described later. Alternatively, hardwired circuitry may be used in place of or in combination with software instructions to implement processes described herein. Thus, implementations described herein are not limited to any specific combination of hardware circuitry and software.

FIG. 3 is a diagram of exemplary functional components of server 210. As shown in FIG. 3, server 210 may include a comments component 410, comments database 120, a search engine component 420, and a search index 430. In another implementation, server 210 may include more or fewer functional components. For example, one or more of the functional components may be located in a device separate from server 210.

Comments component 410 may interact with clients 205 to obtain and/or serve attribute selections as well as comments. For example, a user of a client 205 may access a particular document and generate attribute type selections, such as a like/dislike rating.

Client 205 may send the selected attribute information attribution regarding a selected passage in the document to comments component 410.

Comments component 410 may receive the selection provided by a client 205 in connection with the particular document. Comments component 410 may gather certain information regarding the selection, such as information regarding the author of the comment, a timestamp that indicates a date and/or time at which comment was created, the content of the comment, and/or an address (e.g., a uniform resource locator (URL)) associated with the document.

It is presumed that for certain sites, a visitor must somehow affiliate with the host site (e.g., the web site which opinions or ratings are being expressed) by logging on, or by some like means.

Comments component 410 may receive at least some of this information from client 205 directly from user/visitor or by some indirect means. Comments component 410 may store the information regarding the selection in comments database 120.

Comments component 410 may also serve a selection in connection with a passage in a different document accessed by a client 205. In one implementation, comments component 410 may obtain a selection from comments database 120 and provide that selection to client 205 when client 205 accesses a document with which that selection is associated in comments database 120, or when client 205 requests access to a link associated with the selection.

Comments database 120 stores received attribute information from all. A semantic engine analysis module (not shown) processes the selections to generate a user friendly visual. In one implementation, a graphical user interface is provided which includes a multi-dimensional map to represent the attribute information, and the electronic content. In one scenario, the multi-dimensional map comprises at least color, size and direction characteristics.

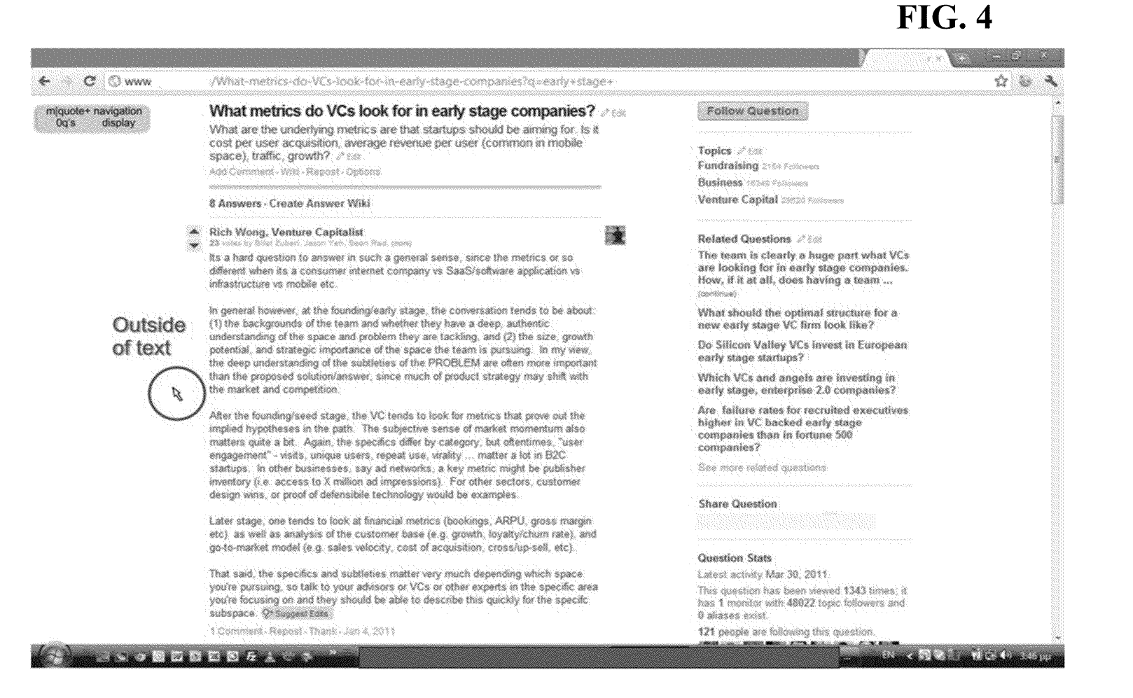

FIGS. 4-15 are screen shots for graphically communicating attribute information selections associated with content on electronic pages in accordance with various associated exemplary embodiments.

In an exemplary embodiment, servers 210-220 provide the content and are able to identify the type of operating system used by user and on that basis switch from, for example, mouse input to finger driven gesture input.

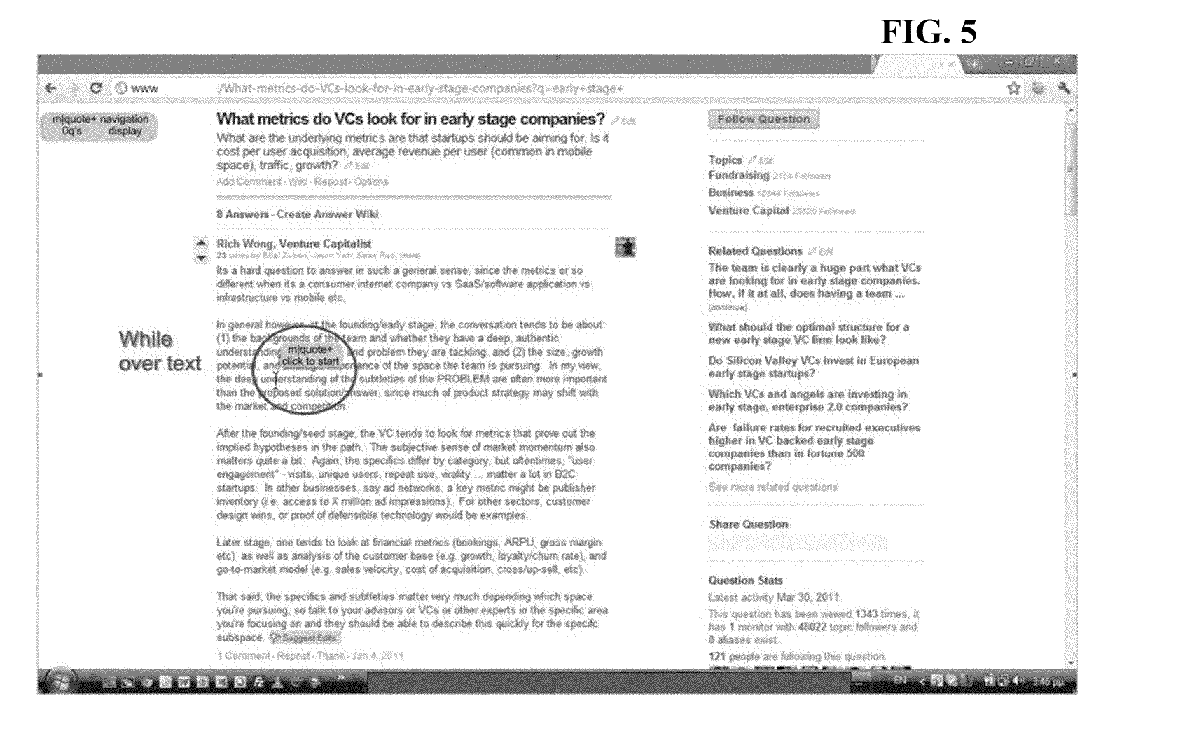

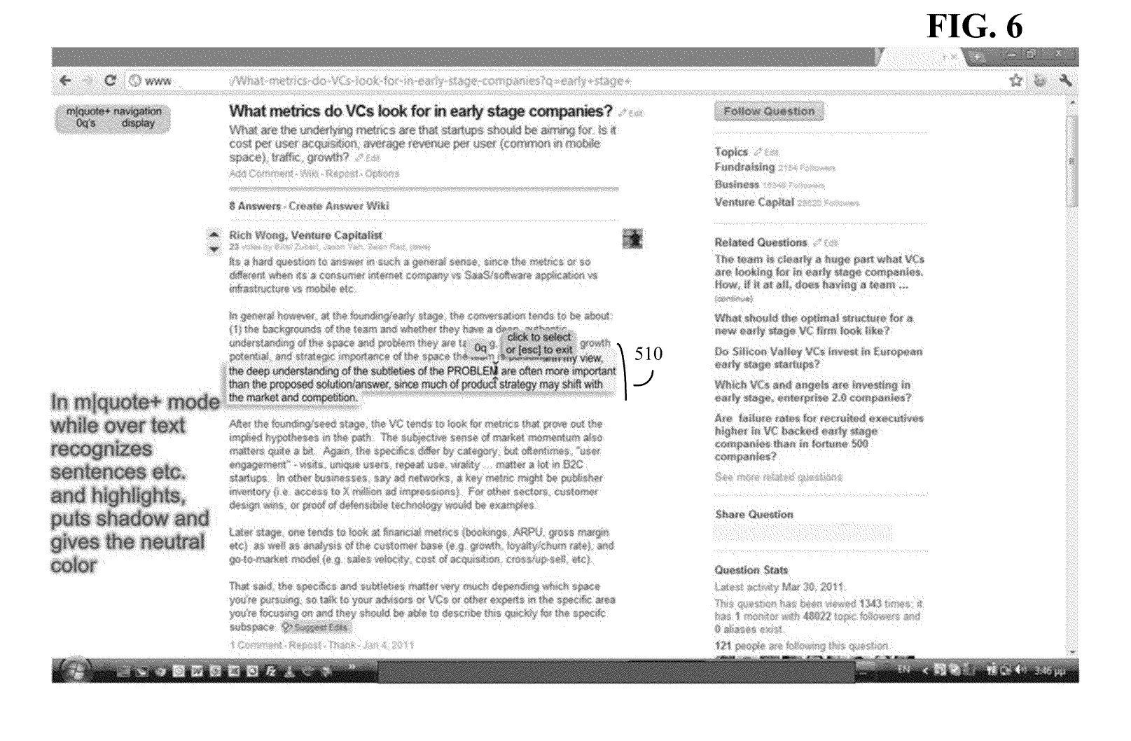

When a user has his mouse over a content area where commenting/attribution is not available/possible, a cursor will be in its normal state (as shown in FIG. 4). As the user moves across an area on the screen that can be commented on, the cursor will change shape and may even be allowed to display a simple hint (FIG. 5). The cursor change and/or hint communicate that a commenting mechanism is available in this area. Information may likewise be provided (in the form of a pop-up window, for example) to provide user interface assistance on how to use the commenting mechanism.

In one scenario, the content owner sets or defines which content is available for commenting and with which predefined parameters commenting will be available: expressions, ratings, etc.

A user may enable commenting by way of any user input, such as by mouse click or finger gesture, over the text or image one desires to comment on. The to-be commented section or sections are then cached in temporary memory. A further selection input may include for example an indication as to which parts of any content is to be commented on which will be helpful to any future semantic analysis engines.

In one scenario, the commenting options available for the user to indicate include paragraphs, sentences, parts of sentences (phrases, between commas or inside parenthesis i.e.), faces, human figures, dresses, shoes, objects, and the like. Alternatively, any break down to parts can also be already predefined by content owner and not analyzed in real time.

This break down in parts allows placement of handles internally in the database serving the content in order for parts to be associated with user interactions and used in a later stage by a semantics analysis engine to analyze interactions more efficiently.

In an alternate scenario, as the mouse hovers over text or images, the user is provided with a user friendly interface to inform the user of sections that can be commented on. A selection scheme then allows the user to select that section for commenting as shown in FIG. 6.

Selection and Quote Process

In one exemplary embodiment, when a user is over a point of interest that is highlighted with a neutral color (e.g., item 510 in FIG. 6), by clicking the mouse button once, a sentence or a part of an image that is directly underneath gets selected, the system locks the cursor in the page and display's a small “hint” on the one side of the page to assist the user on the inputting process (e.g., indications may appear explaining what keys may be used to enter specific notes or comments).

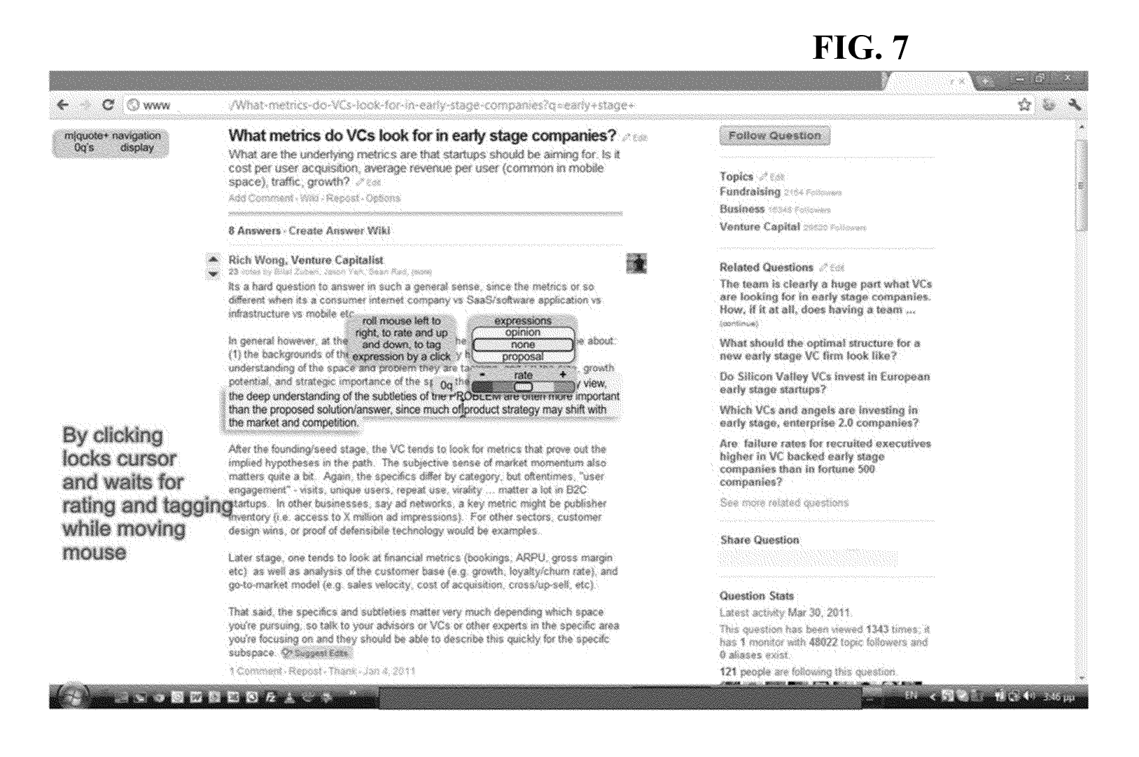

On the opposite side of the page there may be displayed in vertically orientated cross pattern formation, as shown in FIG. 7, a set of predefined expressions tags above and below a selected mid null point of the cross and in horizontal orientation a rating scale, for example moving to the right for positive ratings (+1, +2, etc.) and to the left for negative ratings (−1, −2, etc.).

In a further scenario, with the cursor locked in place, a user is allowed to perform the following set of actions simultaneously.
A) By moving the mouse from left to right, assign a rating to selected parts.
B) By moving the mouse vertically up and down, tag an expression to selected parts. By expression is meant an indication of the author, editor, original commenter, etc. as to whether the selected part is a comment area for example.
C) By pressing specific keys (i.e. left ctrl and shift or up and down arrow keys), a specific part can grow or shrink in relation to a previously selected part using as a reference a position of the currently locked cursor.
D) By pressing specific keys (i.e. right ctrl and shift or left and right arrow keys), a highlighted section can grow or shrink in selection in reference to further following parts from locked cursor current position.
E) By pressing “esc” button, cancel a current selection process and return to previous state (FIG. 7).

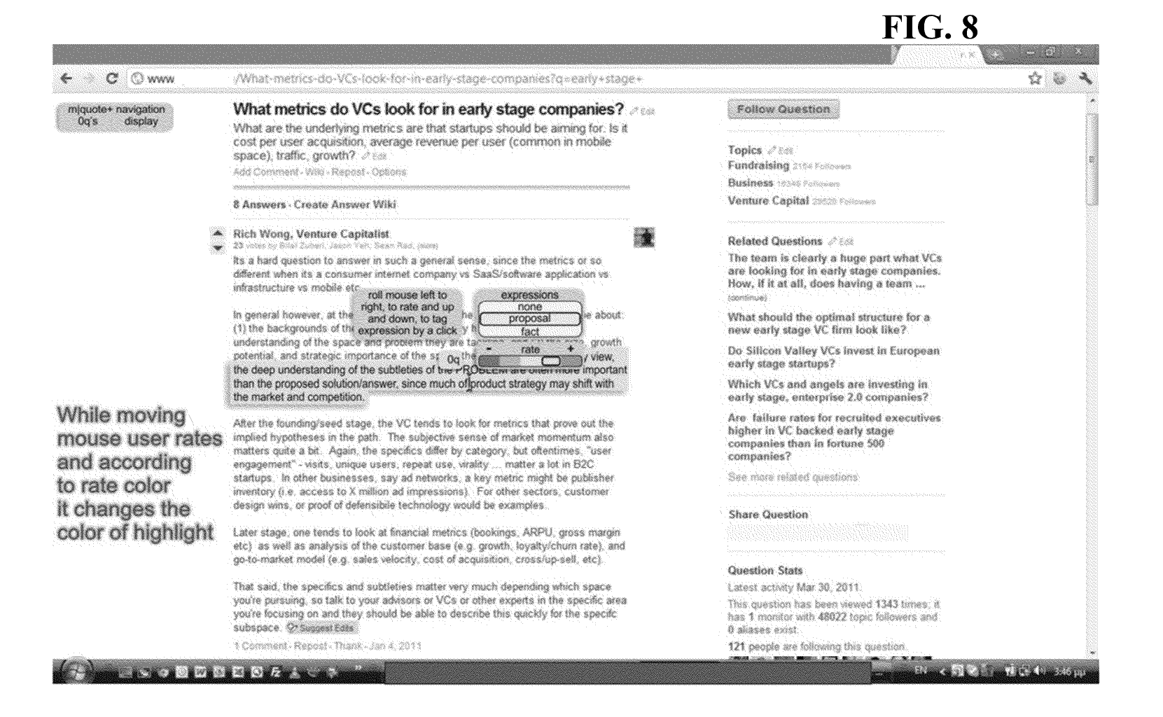

In a further scenario, the user is permitted to assign a rating color of highlight changes (FIG. 8) to the respective color of each rating level (e.g., red for −2, orange for −1, light green for +1 and green for +2).

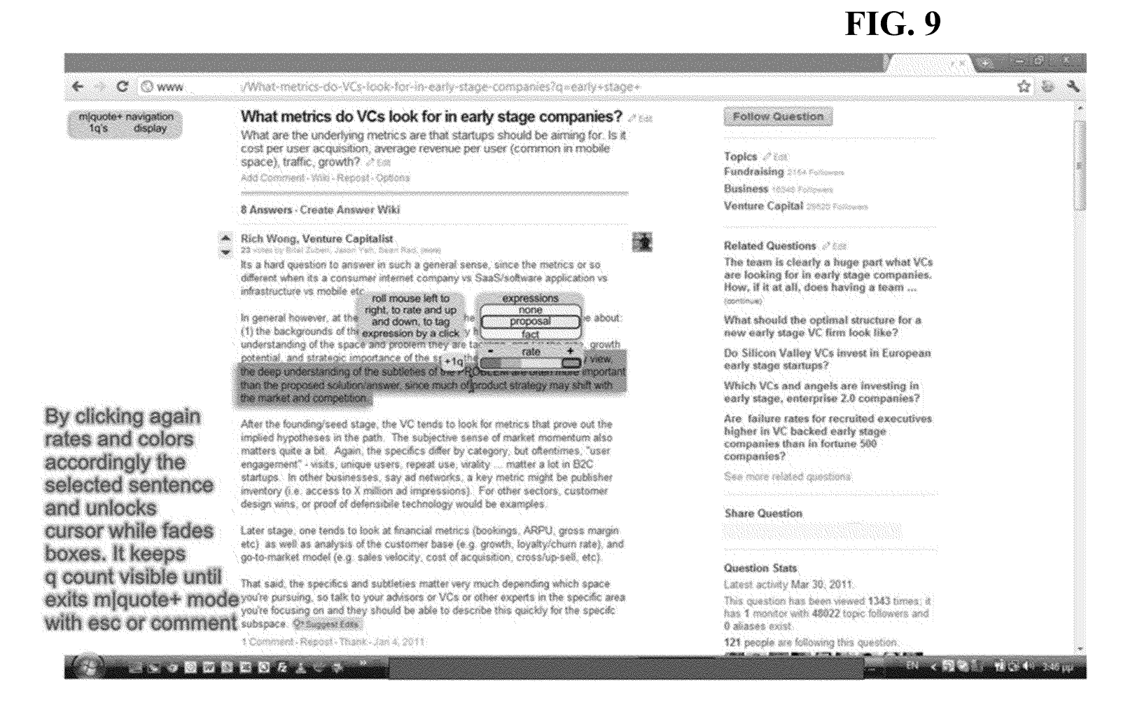

To finalize and store current selection process with interactions, the user mouse clicks again, as shown in FIG. 9. In response to mouse click, the information selected is uploaded to a database of a web server and used to associate with the relevant content a set of records for each selected part or set of parts. In a single or multi part selection, the system will store for each part the following example info.

A) Associated part identifier

B) Assigned rating

C) Expression tagged

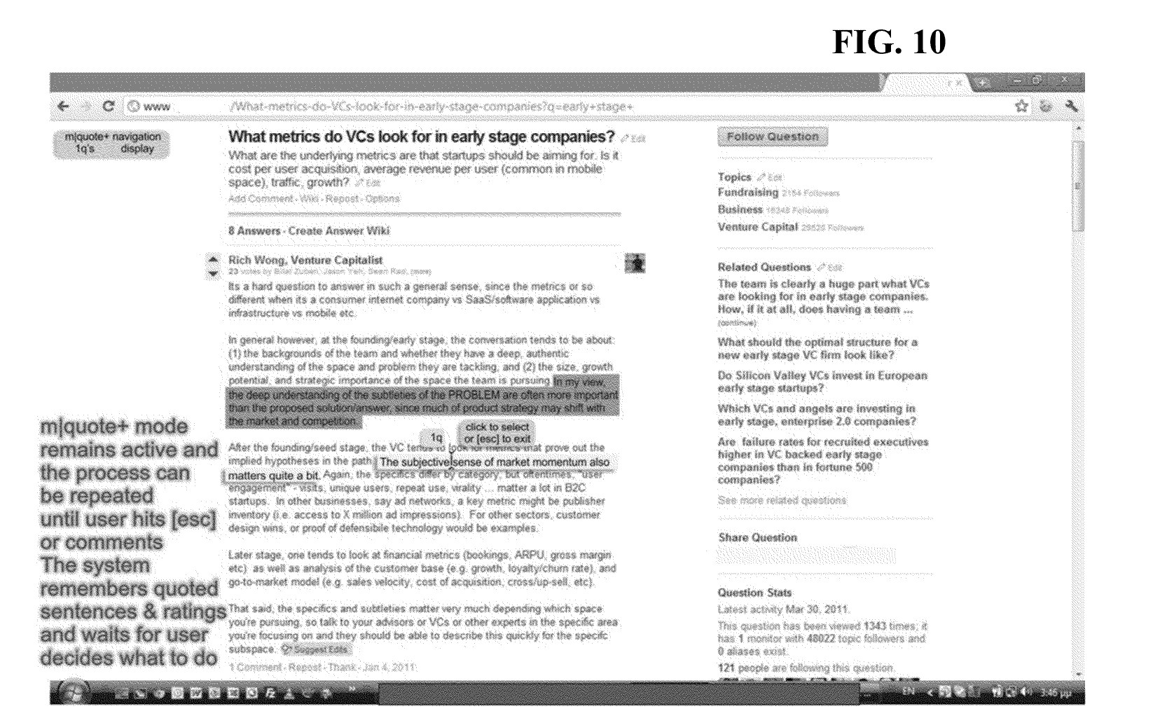

In a further scenario, color marking is maintained throughout the session and added to selected parts. A temporary list of quotes may be included which will be used for more specific commenting on by the user. In addition, fading boxes (balloon hints) may be employed to indicate a +1q condition (i.e., quote count incremented by “one”) in the temporary display in the top left corner and on the cursor hint (FIG. 10).

In another scenario, when a user double clicks on a quote, this may allow him to remove it, and if this is an already-commented-on quote, to make changes to it.

In another exemplary embodiment, instead of a user first mouse-clicking to select and second mouse-clicking to finish the selection indication, tagging and rating process, the same can be achieved by holding on the mouse button while selecting expressions, ratings and adding/removing parts. The releasing of the mouse button then indicates intent to terminate selection. Canceling might involve simply hitting “esc” while holding the mouse button.

Commenting and Finishing Process.

Selection and quoting process can be repeated as many times as needed by the user until satisfied. At this point user has to decide to finalize the process without further commenting by pressing “esc” key or to finalize it by commenting.

If user doesn't want to further comment by simply pressing of “esc” key, the selection information is stored in a database for further analysis and/or to be used to present a more informative representation to all other users.

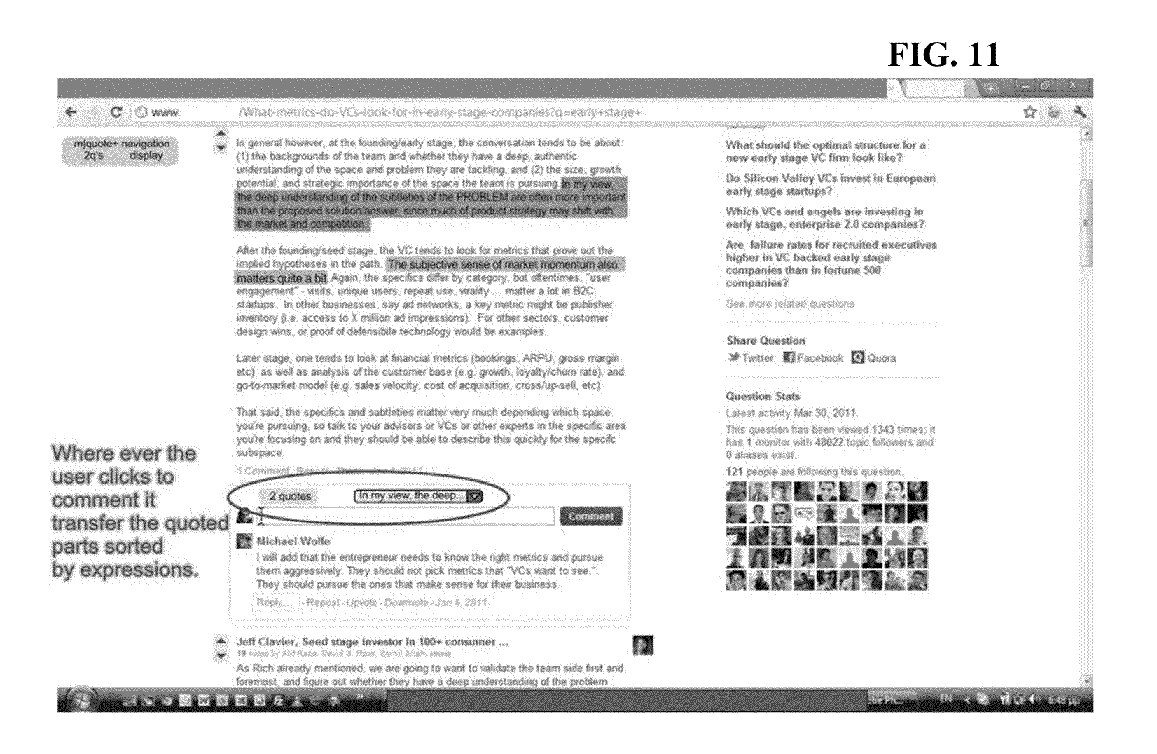

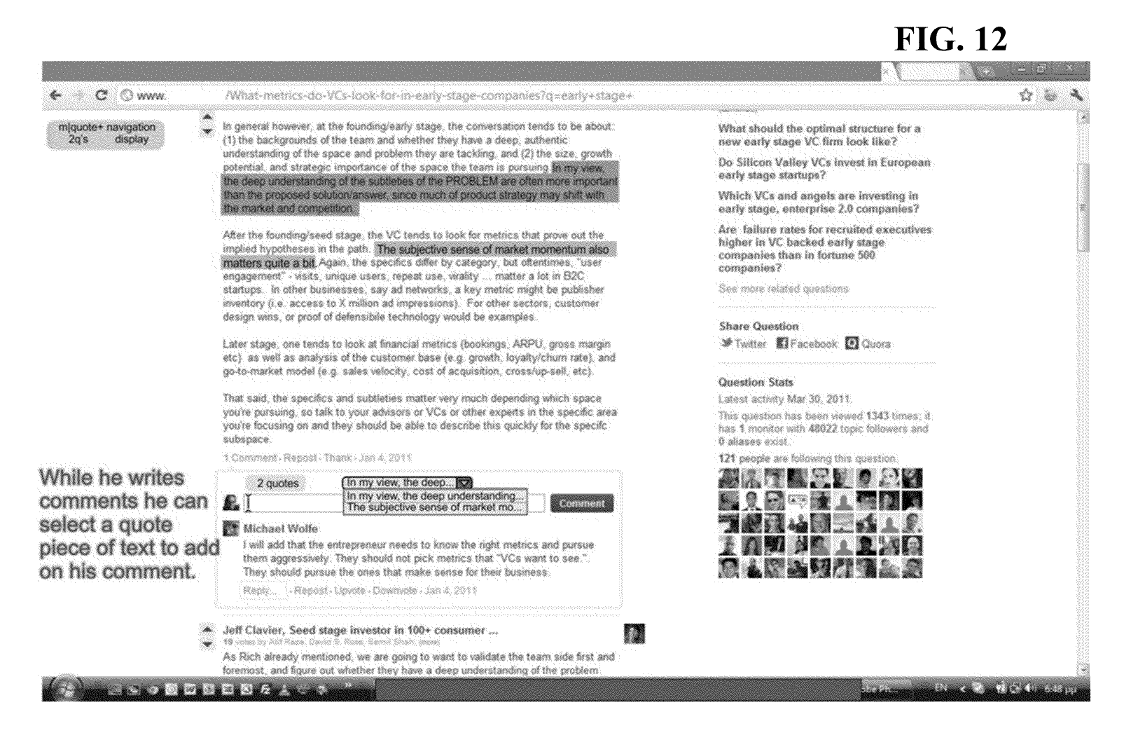

When a user decides to comment, the user selects where to comment (e.g., under author's original text or on a comment of another user). In one scenario, the user is provided with all selected quotes in a form of drop down menu (FIG. 11). Only the first couple of words may be displayed to facilitate their selection and commenting on as show in FIG. 12.

In a further exemplary embodiment, a hierarchy of the user's interactions are stored as separated records each available for easier processing by an appropriate semantics analysis engine. In this regard, a complete interaction thread of comments, replies and quotes are stored and used with associated expressions and ratings for ease of analysis and/or representation. The user is able, while logged in, to view in highlighted form, those quotes and comments inserted or created from previous sessions. This is to help avoid re-evaluating the same parts of an electronic document, as well as to be able to go back and modify ones ratings and expressions (initiated such as by double clicking on them for example).

The proposed solution allows for the efficient collection of comments and other input from many users, recording a wide range of interactions, and storing them in a relational database. The substantial human input involved in the commenting process described and the method of storing this information as proposed (along with the original rest of the content) substantially increases the efficiency of semantics analysis engines.

As has been explained above, with simple mouse actions user are able to perform a set of interactions at once in order to express a quantitative rating (positive or negative), tag an expression from a pre-defined set of expressions and at same time capture a selected range of text or image portion to be possibly quoted or highlighted in a comment.

Once the information is stored and collected in the manner described above, there is a need to be able to intelligently and effectively share this information.

In yet a further embodiment, this information is employed to generate a graphical user interface including a multi-dimensional map to represent the attribute information, and the electronic content, where the multi-dimensional map comprises at least color, size and direction (i.e. left and/or right) characteristics.

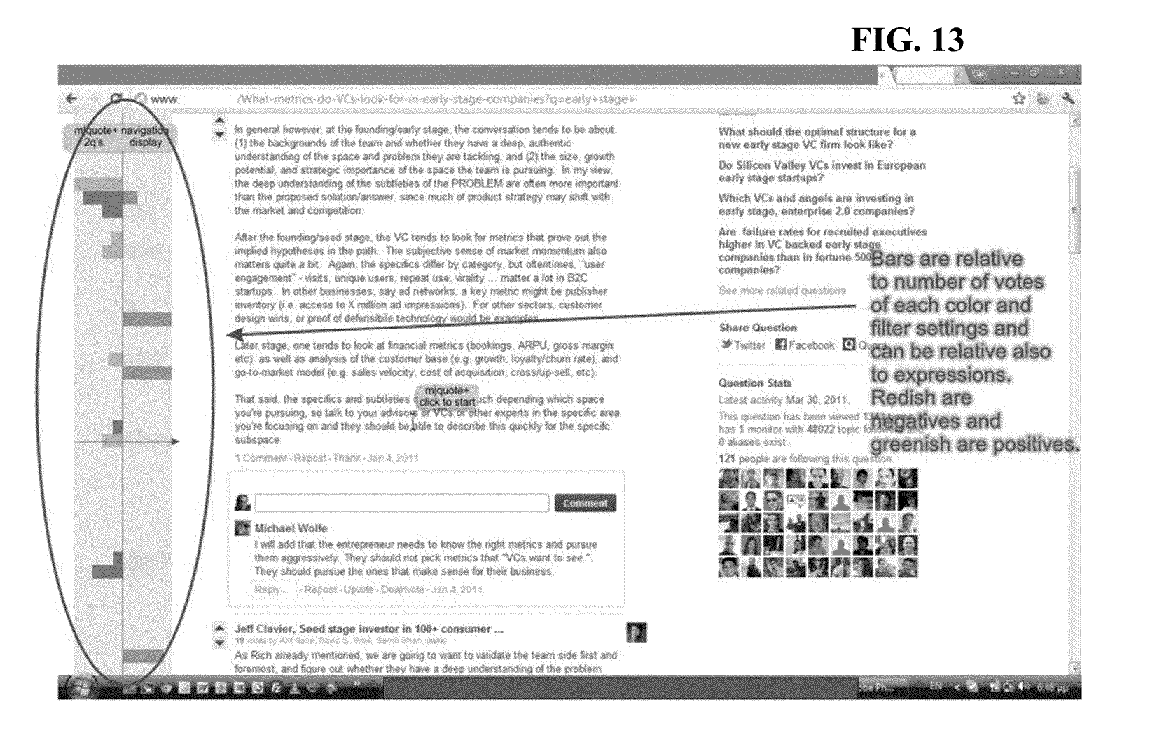

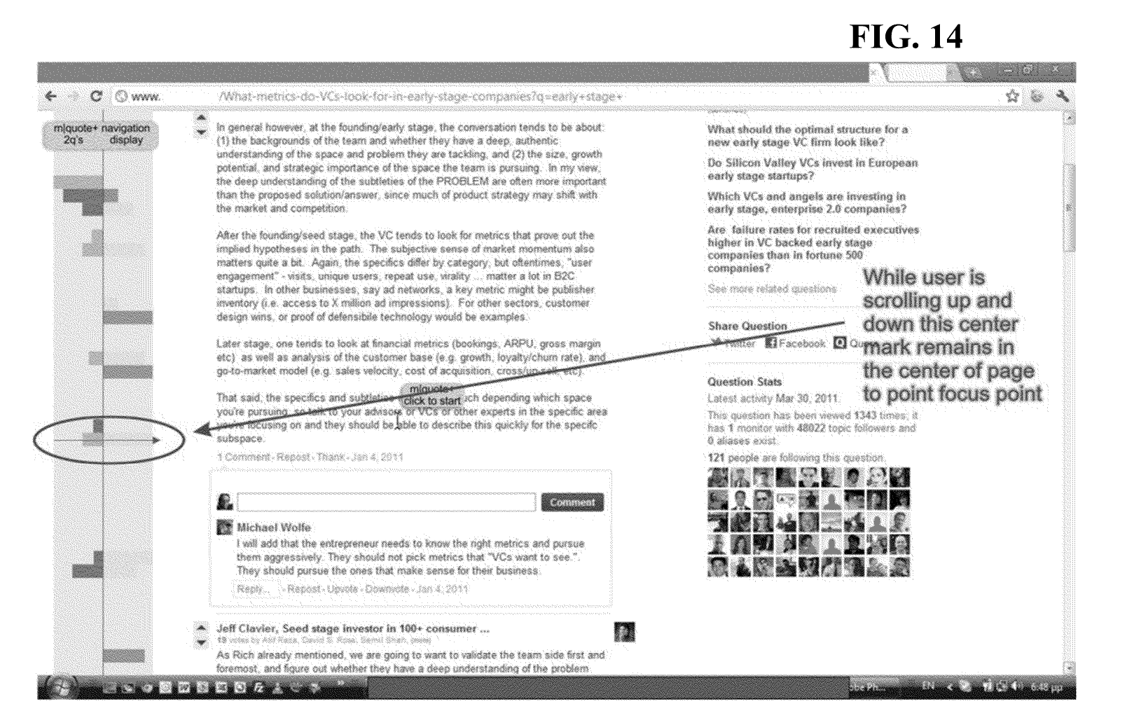

An improved multi-dimensional mapping scheme in accordance with yet further exemplary embodiment is shown and described with reference to FIGS. 13-15.

The mapping scheme proposed herein allows a viewer to quickly extrapolate information from synthesized attribute information so as to be able to quickly perform a fast access “jump” to specific points of interest in the information.

In an exemplary embodiment, the mapping scheme includes color bars which are employed to convey a positive/negative rating scale in relation to a corresponding selected expression.

The same bars can have dimensional parameters (such as 2× or 3× dimensional) length/width/area/volume which combined with color attribute (positive/negative ranking) allows a viewer to visually process synthesized data about expressions of interest.

An exemplary mapping scheme is derived from a preexisting database that supplies the appropriate data of expressions like “opinion”, “proposal”, “fact” etc. Additionally on each expression is associated a user rating positive or negative in a scale of −2. −1, none, +1, +2. Both expressions and ratings are assumed to be associated with specific lines of text or image within the commenting content, these associations have being created by other users using the previously mentioned advanced quoting tools that allow more targeted commenting to the level of specific phrase or image part and not only to comments as a whole.

The proposed invention apart from the typical tools of sorting by submission date and time, by most voted and such, adds another tool that doesn't sort but instead allows user to jump to the point of interest. As it being presented on FIG. 13, there is a vertical graph on the left side of the screen that is split in the center. On the left side, the bar is used to represent negative votes. The right side represents and communicates positive votes.

In the illustrated embodiments, each bar provides a visual synthesis of interactions which take place on a single line of text next to a bar. At the top of the bar graph, a cross hair FIG. 14 appears in position even as a viewer scrolls up and down to provide a focus point. In more specific terms when scrolling up and down bars are moving in connection to the rest of text and image content while the cross hair pointer remains in position and shows in which particular line the focus of the tool is.

On each line there are possible assigned expressions and/or ratings from a plethora of users. Present invention represents the amount of negative and positive ratings (votes) on the same time with the size of the bars and the color of the bars.

The size of the bars is related to the relative amount of given ratings (votes), more ratings, bigger the bar is from the center towards to the appropriate side, negative (left) or/and positive (right).

The color of the bars is related to the intensity of the ratings so more ratings with +2 the greener will be the color of the positive bar, more +1 the less green will be the color. The more −2 ratings, the more reddish the negative bar will be and so on.

Both bars, positives and negatives, can coexist since they represent the whole set of ratings and not only the one or the other.

In this way the user with one quick look can identify the points of interest while scrolling from the top of the page to the bottom.

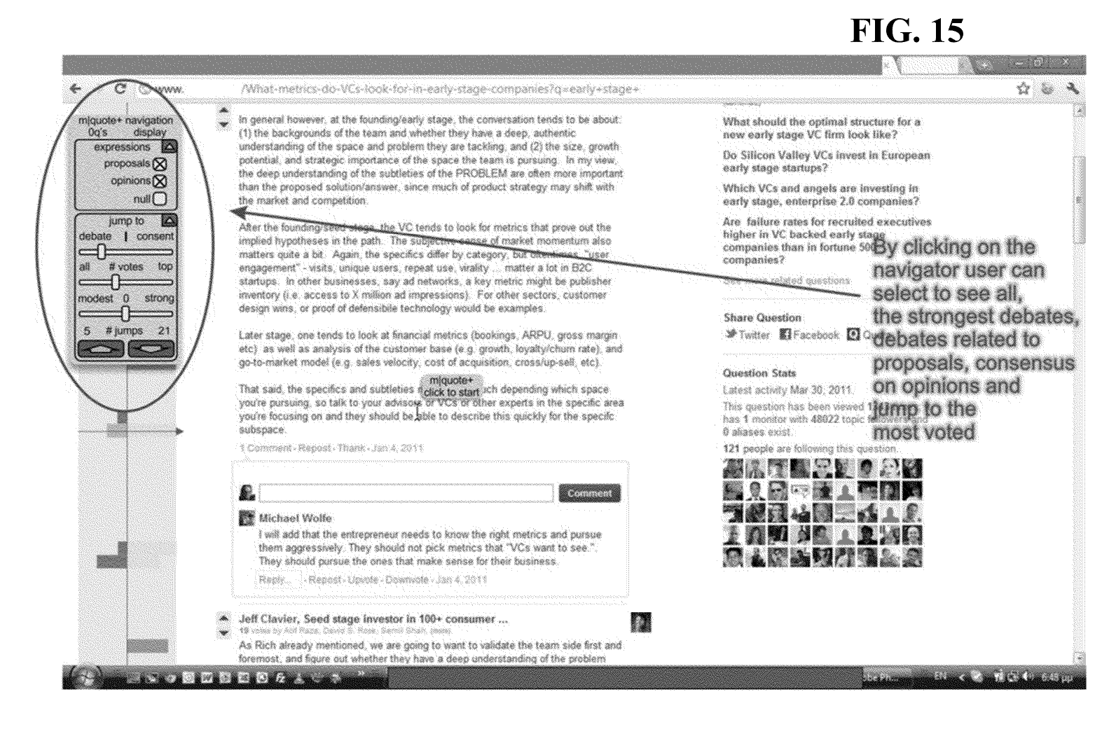

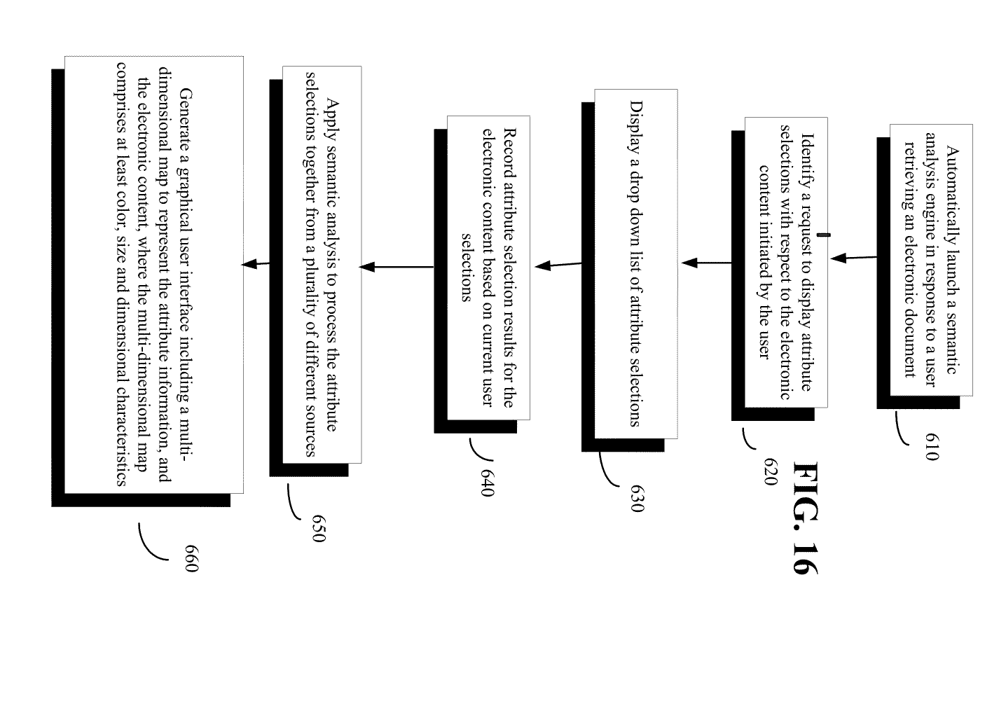

In a more preferred embodiment on a floating control box FIG. 15 on the top left of the page (which can also be moved to the bottom by user drag and drop action) there is a drop down array of controls that allows the viewer to request different processing and filtering of the bar-graph as well as to jump to a focus point of interest using a set of previous/next graphic buttons.

In more specific terms, a viewer is able to filter provided information by a multiple selection choice visual of expressions or a single expression. Filtering process will impact the bar graph representation that will only use the specific range of ratings related to the expressions selected.

Additionally user is able to jump in specific focus points by selecting a debate or consensus magnitude with a slider, in a second slider user can set a threshold of the amount of ratings to be processed, all or up to top i.e. 20% and on a third slider user can filter the opinion dynamics between modest, non preference to strong.

In more specific terms a magnitude of a debate is being defined by the amount of opposite ratings (votes), positive and negatives being equally distributed i.e. 10 positives with 10 negatives will result to a maximum debate on the other hand the magnitude of consensus is derived by the amount of unequally distributed ratings (votes) i.e. 10 positives and 0 negatives will result to a maximum consensus. A mid point would be i.e. 5 positives and 10 negatives.

In a preferred embodiment the quantitative essence of ratings i.e. stronger positive votes in +2 scale and less stronger negative rating of −1 will result i.e. to a more positive consensus weight of the result. In this way the proposed invention will take into account the opinion dynamics of debates and/or consensus points. Opinion dynamics are stronger when users are using stronger ratings or more modest ratings to express their ratings.

In another preferred embodiment the proposed invention will also filter dynamics thus allowing user to focus on more strong arguments or to more modest discussions.

In a preferred embodiment every time that a value of the processing has changed, in the control box presented on FIG. 15 above jump graphic arrow buttons they will be displayed in real time the available jump points before and after the current focus point.

In another preferred embodiment user can click on the top of the control box to toggle between, minimum view no bar graph, minimum view with bar graph and full view with bar graph and so on. Additionally in full view user can drop down both or either one, “expressions” controls or “jump to” controls to save real estate of the user interface while always having visible the jump keys.

Present invention enables user by using this entire array of tools to be able to jump to focus points faster and more efficiently without wasting too much time on reading everything in order to have a digested view of the underlining content.

Additionally due to the inherit ability of the mind to discriminate fast visual differences the way the proposed multi-dimensional map is displayed, with colors, size and direction optical triggers, allows the user to fast identify, even by eye, the point of interest by just scrolling the page with the attributed comments.

In a further exemplary embodiment, servers 210-220, serve up ads (such as Google Ads, Amazon Ads, ads from affiliate networks with which the site owner is associated, or like type of static and/or dynamic ad server mechanisms), based on either keywords associated with the comments themselves and/or the rating results.

In another scenario, the comments and/or ratings are matched to promotional schemes aimed at encouraging participation in the process. Advanced game theory mechanics may be employed for example to cause a trigger event when a certain combination of events occurs in relation to the commenting and/or rating activities engaged on by the users.

Most comments occur at or about the time of initial publication. For example, it is possible to have thousands of commenters wishing to sign on and comment on a popular op-ed column in the Sunday New York Times.

In accordance with a further embodiment, commenting on an article is limited in time and duration in order to illicit the maximum response from the maximum number of people.

In another scenario, the commenting and/or rating sections are mapped in a 3-dimensional space (sort of like a 3d-file system) to allow for visual effect and interpretation of results.

FIG. 16 is a high level flowchart in accordance with an exemplary embodiment.

The process of annotating electronic content on an electronic document starts by the launching of a semantic analysis engine in response to a user retrieving an electronic document (610). The semantic analysis engine is the tool that facilitates attribute information processing. Once launched, the semantic analysis engine identifies a request to display attribute selections with respect to the electronic content initiated by the user (620). A drop down list of attribute selections (630) is displayed. A recording of attribute selection results for the electronic content is performed based on current user selection actions (640). These actions may be performed by hovering a mouse over selection, via gesturing, via voice or biometric commands, or the like, as previously explained.

Semantic analysis is applied to process the attribute selections together from a plurality of different sources (650). The different sources are each of the annotators that visited the authored site and which generated relevant attribution information; or annotators providing annotations from remote sources, either by having received quotes to passages from previously annotators to the site, or from the same passage appearing in different articles by different sources, but compiled by a common server connected to each and capable of semantic analysis to generate mapped attribute information.

A graphical user interface is finally generated that includes a multi-dimensional map to represent the attribute information from all annotators with respect to each annotated passage (electronic content). The multi-dimensional map includes color, size and dimensional characteristics (660) which make it possible for the reader or next annotator to quickly extract important details about an article, news source, product description, etc. without having to read (line-by-line and word-by-word) every passage.

The benefit is that through clever process of annotating described herein, a community of annotators can come together in an easy, user-friendly way, to help a wider audience of reader and other annotators focus their time, energy, and resources, on articles and other electronically available content that are truly worth it.

In an exemplary embodiment, selection of attribute information is facilitated by drop down menus that are generated on or near a selected passage (electronic content) to be notated. Intuitive mouse actions provide activate, select, deselect, delete and/or rotate functionality and control. In an alternate scenario, speech processing and/or biometric type selection is provided.

In yet a further exemplary embodiment, attribute selection functionality is triggered by intuitive gestures. In one implementation, a gesturing approach involves using two fingers, or a thumb and a finger, to perform a multitude of functions. Gesturing is a more suitable notation methodology for smaller portable devices, such as smart phones and similar touch screen enabled tablet devices, where there is no mouse. In one implementation, gesturing is achieved by a user's thumb, in the hand holding the device, tapping “on or near” a corner of a screen real estate, while an index finger in the opposite hand scrolls, selects, deselects. Other gesturing methods, including a combination of any of the above described techniques, are also contemplated.

In a further scenario, in addition to selection of attribute information there is provided the ability to not only identify a passage to be annotated, but also to “pull” the passage as a quote into a comment field section.

In a further scenario, the quote, once selected may be set off as a link and shared by way of email, uploaded to a social network site for others to comment. Once link shared, the link remains dynamically linked back to the authoring page, and any attribute information generated by one or more users at the receiving end (e.g., on FACEBOOK or TWITTER) are processed and mapped in the same way as if the attribute information were made on the author's site.

In one implementation, a remote server automatically activates an appropriate software module to enable the annotation tool. The software module is activated in response to the same server or a related server receiving a request from a client device to make an electronic document available to it.

In another scenario, the software module is local to the client device and activated by a browser downloading a web page, email, electronic document, a received quote from another client, or automatically when logging in to a particular site, or social network community, such as FACEBOOK or TWITTER.

In yet a further scenario, the electronic document is a non-web page document with the annotation tool being provided as add-on tool, e.g., (i) to a word processing program, such as WORD; or (ii) to an image creation too, such as VISIO. When the non-web page document is distributed or otherwise shared among a large community of members, the annotation tool is either active on the background when the document is launched by the relevant executable program, or otherwise launched by the client device of the individual member when opening the non-web page document.

In yet a further implementation, the mapping of attribute information results in being able to identify a range of different user participation activity—as evidenced by the number of user selections to generate attribute information—about a particular passage or sets of passages. An area of high interest and activity provides a variety of targeted advertising, and opens the door for a variety of monetization schemes. In one monetization strategy, the owner of the site may vary the price it charges for advertising based on the level of visitor interest, as determined by dynamically provided and mapped attribute information, about a particular topic.

In another monetization strategy, the advertiser is a dynamically generated advertisement served up by an ad server with which the site is registered, such as Google Adsense, Google Adwords, affiliate managers such as Amazon, Linkshare, and like ad serving platforms.

In one implementation, the ad serving platform scans the page to analyze the mapped attribute information. Image recognition is employed to identify—based on interpretation of graphical contents—the areas of highest activity, and thus most valuable from ad placement perspective. Premium ads are served at areas of high activity. Advertisers may charge different prices for targeted advertising to the same or different customers based on activity level of attribution information about a given page,

When the affiliate ad is an embedded word type ad generated by hovering over a certain keyword or keywords (for example “SAMSUNG GALAXY”), or an image of a device associated with these same words, then the value to acquire such words or images, is set at a premium when they appear in high activity areas.

Passages in high activity areas—in terms of attribution information mapping—are also more likely to be quoted in relevant commenting fields or exported to other members and/or community network sites. When this occurs, embedded ads are circulated beyond the original site, creating an opportunity for exposure to a wider audience.

In an alternate monetization approach, an ad manipulation tool is provided which changes embedded ads associated with quotes that are reproduced in comment fields, and/or exported. The changes may involve (i) simply changing the tracking id in the ad to the annotator-associated tracking id for that same merchant or advertiser, or, alternatively, (ii) completely replacing the ad with a different ad from a different merchant or advertiser with whom the annotator is affiliated.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

Further, it has been described that scores are generated for comments. The scoring scheme has been described where higher scores are better than lower scores. This need not be the case. In another implementation, the scoring scheme may be switched to one in which lower scores are better than higher scores.

Also, it has been described that users create comments regarding documents. In another implementation, comments may be created for portions of documents. A “document portion,” as used herein, is intended to refer to less than the entire document. The document portion may include some amount of text (e.g., some number of words), an image, a video, or some audio.

It will be apparent that aspects described herein may be implemented in many different forms of software, firmware, and hardware in the implementations illustrated in the figures. The actual software code or specialized control hardware used to implement aspects does not limit the embodiments. Thus, the operation and behavior of the aspects were described without reference to the specific software code—it being understood that software and control hardware can be designed to implement the aspects based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The foregoing description of a preferred embodiment and best mode of the invention known to the applicant at this time of filing the application has been presented and is intended for the purposes of illustration and description. It is not intended to be exhaustive or limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims. In another similar scenario, the agent is a social network community platform such as Facebook, MySpace, or smaller communities, such as corporate communities of employees, common interest groups, and similar platforms.

In one or more exemplary embodiments, the functions described may be implemented in hardware, software, firmware, or any combination thereof. If implemented in software, the functions may be stored on or transmitted over as one or more instructions or code on a computer readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer-implemented method of annotating electronic content on an electronic document, comprising:
launching a semantic analysis engine in response to a user retrieving and electronic document;
identifying a request to display attribute selections with respect to the electronic content initiated by the user;
displaying a drop down list of attribute selections;
recording attribute selection results for the electronic content based on current user selections;
applying semantic analysis to process the attribute selections together from a plurality of different sources; and
generating a graphical user interface including a multi-dimensional map to represent the attribute information, and the electronic content, where the multi-dimensional map comprises at least color, size and dimensional characteristics.

2. A computer readable product stored on a non-transitory computer readable medium for annotating electronic content on an electronic document and including instructions for causing a processor to:
launch a semantic analysis engine in response to a user retrieving and electronic document;
identify a request to display attribute selections with respect to the electronic content initiated by the user;
display a drop down list of attribute selections;
record attribute selection results for the electronic content based on current user selections;
apply semantic analysis to process the attribute selections together from a plurality of different sources; and
generate a graphical user interface including a multi-dimensional map to represent the attribute information, and the electronic content, where the multi-dimensional map comprises at least color, size and dimensional characteristics.

3. A system for annotating electronic content on an electronic document, comprising:
means for launching a semantic analysis engine in response to a user retrieving and electronic document;
means for identifying a request to display attribute selections with respect to the electronic content initiated by the user;
means for displaying a drop down list of attribute selections;
means for recording attribute selection results for the electronic content based on current user selections;
means for applying semantic analysis to process the attribute selections together from a plurality of different sources; and
means for generating a graphical user interface including a multi-dimensional map to represent the attribute information, and the electronic content, where the multi-dimensional map comprises at least color, size and dimensional characteristics.
